(19) United States
(12) Patent Application Publication
(10) Pub. No.: US 2025/0016868 A1
(43) Pub. Date: Jan. 9, 2025

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP); Jing Wang, Beijing (CN); Lan Chen, Beijing (CN)

(73) Assignee: NTT DOCOMO, INC., Tokyo (JP)

(21) Appl. No.: 18/705,980

(22) PCT Filed: Oct. 29, 2021
(86) PCT No.: PCT/JP2021/040037

§ 371 Date: Apr. 29, 2024

(51) Int. Cl. H04W 76/20; H04B 7/06; H04W 52/36

(52) U.S. Cl. CPC H04W 76/20; H04B 7/0626; H04W 52/365

(57) ABSTRACT

A terminal according to one aspect of the present disclosure includes a receiving section that, when a separate Transmission Configuration Indication (TCI) state is applied to each of a downlink (DL) and an uplink (UL), receives a specific configuration for enabling or disabling initiation of activation of the TCI state of at least one of the UL and the DL by a UE, and a control section that initiates activation of the TCI state. According to one aspect of the present disclosure, an appropriate TCI state can be activated.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, NR), it is studied that a user terminal (terminal, User Equipment (UE)) controls transmission/reception processing, based on a Transmission Configuration Indication (TCI) state.

It is studied that, for the UE, the same TCI state (joint TCI state) is applied to the UL and the DL or a separate state (separate TCI state) is applied to each of the UL and the DL.

However, a detailed design of activation of a TCI state when at least one of the joint TCI state and the separate TCI state is applied has not been clarified. This may cause reduction of communication throughput, without an appropriate TCI state being activated.

In view of this, the present disclosure has one object to provide a terminal, a radio communication method, and a base station for enabling activation of an appropriate TCI state.

### Solution to Problem

A terminal according to one aspect of the present disclosure includes a receiving section that, when a separate Transmission Configuration Indication (TCI) state is applied to each of a downlink (DL) and an uplink (UL), receives a specific configuration for enabling or disabling initiation of activation of the TCI state of at least one of the UL and the DL by a UE, and a control section that initiates activation of the TCI state.

### Advantageous Effects of Invention

According to one aspect of the present disclosure, an appropriate TCI state can be activated.

### BRIEF DESCRIPTION OF DRAWINGS

FIG. 1A and FIG. 1B are diagrams to show examples of a configuration of TCI states.

FIG. 2 is a diagram to show an RRC configuration of a TCI state and QCL information in Rel. 16.

FIG. 3 is a diagram to show a CSI report in Rel. 16.

FIG. 4 is a diagram to show an example of update of TCI states according to a second embodiment.

FIG. 5 is a diagram to show an example of update of TCI states according to a third embodiment.

FIG. 6A and FIG. 6B are diagrams to show examples of update of TCI states according to a ninth embodiment.

FIG. 7A and FIG. 7B are diagrams to show examples of update of TCI states according to a tenth embodiment.

FIG. 8 is a diagram to show an example of a schematic structure of a radio communication system according to one embodiment.

FIG. 9 is a diagram to show an example of a structure of a base station according to one embodiment.

FIG. 10 is a diagram to show an example of a structure of a user terminal according to one embodiment.

FIG. 11 is a diagram to show an example of a hardware structure of the base station and the user terminal according to one embodiment.

FIG. 12 is a diagram to show an example of a vehicle according to one embodiment.

### DESCRIPTION OF EMBODIMENTS

### (CSI Report)

In Rel-15/16 NR, a UE measures a channel state by using a certain reference signal (or resources for the reference signal), and feeds back (reports) channel state information (CSI) to a base station.

The UE may measure the channel state by using a channel state information reference signal (CSI-RS), a synchronization signal/broadcast channel (Synchronization Signal/Physical Broadcast Channel (SS/PBCH)) block, a synchronization signal (SS), a demodulation reference signal (DMRS), or the like.

A CSI-RS resource may include at least one of a non zero power (NZP) CSI-RS and CSI-Interference Management (IM). The SS/PBCH block is a block including a synchronization signal (for example, a primary synchronization signal (PSS)), a secondary synchronization signal (SSS), and a PBCH (and a corresponding DMRS), and may be referred to as an SS block (SSB) or the like. An SSB index may be given to a time position of the SSB in a half frame.

Note that the CSI may include at least one of a channel quality indicator (CQI), a precoding matrix indicator (PMI), a CSI-RS resource indicator (CRI), an SS/PBCH block resource indicator (SS/PBCH Block Indicator (SSBRI)), a layer indicator (LI), a rank indicator (RI), Layer 1 (L1)-Reference Signal Received Power (RSRP) (reference signal received power in layer 1), L1-Reference Signal Received Quality (RSRQ), an L1-Signal to Interference plus Noise Ratio (SINR), an L1-Signal to Noise Ratio (SNR), and the like.

The CSI may include a plurality of parts. A first part of the CSI (CSI part 1) may include information (for example, the RI) having relatively a small number of bits. A second part of the CSI (CSI part 2) may include information (for example, the CQI) having relatively a large number of bits, such as information determined based on CSI part 1.

As a method for feeding back the CSI, (1) periodic CSI (P-CSI) reporting, (2) aperiodic CSI (A (AP)-CSI) reporting, (3) semi-persistent (semi-permanent) CSI reporting (SP-CSI) reporting, and the like are under study.

The UE may be notified of information (which may be referred to as CSI report configuration information) related to the CSI report by using higher layer signaling, physical layer signaling (for example, downlink control information (DCI)), or a combination of these. The CSI report configuration information may be, for example, configured using an RRC information element “CSI-ReportConfig”.

Here, the higher layer signaling may be, for example, any one or combinations of Radio Resource Control (RRC) signaling, Medium Access Control (MAC) signaling, broadcast information, and the like.

The MAC signaling may use, for example, a MAC control element (MAC CE), a MAC Protocol Data Unit (MAC PDU), or the like. The broadcast information may be, for example, a master information block (MIB), a system information block (SIB), minimum system information (Remaining Minimum System Information (RMSI)), other system information (OSI), or the like.

The CSI report configuration information may include, for example, information related to a report period, an offset, or the like, and these may be expressed in the unit of certain time (the unit of a slot, the unit of a subframe, the unit of a symbol, or the like). The CSI report configuration information may include a configuration ID (CSI-ReportConfigId). With the configuration ID, parameters such as a type of a CSI report method (whether or not the SP-CSI is used or the like) and a report period may be identified. The CSI report configuration information may include information (CSI-ResourceConfigId) indicating which CSI measured by using which signal (or resources for which signal) is to be reported.

### (Beam Management)

In Rel-15 NR, a method of beam management (BM) has hitherto been under study. In the beam management, performing beam selection based on L1-RSRP reported by the UE has been under study. To change (switch) beams of a certain signal/channel may correspond to changing of a transmission configuration indication state (TCI state) of the signal/channel.

Note that the beam selected through beam selection may be a transmit beam (Tx beam), or may be a receive beam (Rx beam). The beam selected through beam selection may be a beam of the UE, or may be a beam of the base station.

The UE may report (transmit) measurement results for beam management by using a PUCCH or a PUSCH. The measurement results may be, for example, the CSI including at least one of L1-RSRP, L1-RSRQ, L1-SINR, L1-SNR, and the like. The measurement results may be referred to as beam measurement, beam measurement results, a beam report, a beam measurement report, or the like.

CSI measurement for the beam report may include interference measurement. The UE may measure channel quality, interference, or the like by using resources for CSI measurement, and derive the beam report. The resources for CSI measurement may be, for example, at least one of resources of the SS/PBCH block, resources of the CSI-RS, other reference signal resources, and the like. Configuration information of a CSI measurement report may be configured for the UE by using higher layer signaling.

In the beam report, results of at least one of channel quality measurement and interference measurement may be included. The results of channel quality measurement may include, for example, L1-RSRP. The results of interference measurement may include L1-SINR, L1-SNR, L1-RSRQ, other indices related to interference (for example, any index other than L1-RSRP), and the like.

Note that the resources for CSI measurement for beam management may be referred to as resources for beam measurement. A signal/channel as a target of the CSI measurement may be referred to as a signal for beam measurement. The CSI measurement/report may be interpreted as at least one of measurement/report for beam management, beam measurement/report, radio link quality measurement/report, and the like.

The CSI report configuration information in consideration of beam management of NR at present is included in an RRC information element “CSI-ReportConfig”. Information in the RRC information element “CSI-ReportConfig” will be described.

The CSI report configuration information (CSI-ReportConfig) may include report quantity information (which may be expressed as “report quantity”, or an RRC parameter “reportQuantity”) being information of a parameter to be reported. The report quantity information is defined as a type of an ASN.1 object referred to as a “choice type (choice)”. Thus, one of parameters (cri-RSRP, ssb-Index-RSRP, and the like) defined as the report quantity information is configured.

The UE configured with a higher layer parameter (for example, an RRC parameter “groupBasedBeamReporting”) included in the CSI report configuration information being enabled may include a plurality of resource IDs for beam measurement (for example, the SSBRI, the CRI) and a plurality of measurement results (for example, the L1-RSRP) corresponding to these in the beam report regarding each report configuration.

The UE configured with one or more report target RS resources using a higher layer parameter (for example, an RRC parameter “nrofReportedRS”) included in the CSI report configuration information may include one or more resource IDs for beam measurement and one or more measurement results (for example, the L1-RSRP) corresponding to these in the beam report regarding each report configuration.

### (TCI, Spatial Relation, QCL)

For NR, control of reception processing (for example, at least one of reception, demapping, demodulation, and decoding) and transmission processing (for example, at least one of transmission, mapping, precoding, modulation, and coding) of at least one of a signal and a channel (expressed as a signal/channel) in a UE, based on a transmission configuration indication state (TCI state) is under study.

The TCI state may be a state applied to a downlink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information, or the like. The TCI state may be configured for the UE for each channel or for each signal.

QCL is an indicator indicating statistical properties of the signal/channel. For example, when a certain signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have different parameter(s) (or parameter set(s)) that can be assumed to be the same, and such parameter(s) (which may be referred to as QCL parameter(s)) are described below:
QCL type A (QCL-A): Doppler shift, Doppler spread, average delay, and delay spread
QCL type B (QCL-B): Doppler shift and Doppler spread
QCL type C (QCL-C): Doppler shift and average delay
QCL type D (QCL-D): Spatial reception parameter

A case that the UE assumes that a certain control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

The physical layer signaling may be, for example, downlink control information (DCI).

A channel for which the TCI state or spatial relation is configured (specified) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), and a reference signal for QCL detection (also referred to as a QRS).

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An RS of QCL type X in a TCI state may mean an RS in a relationship of QCL type X with (a DMRS of) a certain channel/signal, and this RS may be referred to as a QCL source of QCL type X in the TCI state.

A QCL type A RS may be invariably configured for the PDCCH and the PDSCH, and a QCL type D RS may be additionally configured. It is difficult to estimate Doppler shift, delay, and the like with one-shot reception of the DMRS, and thus the QCL type A RS is used for enhancement of channel estimation accuracy. The QCL type D RS is used to determine a receive beam at the time of reception of the DMRS.

For example, TRSs 1-1, 1-2, 1-3, and 1-4 are transmitted, and TRS 1-1 is notified as a QCL type C/D RS, using the TCI state of the PDSCH. When the TCI state is notified, the UE can use information obtained from results of past periodic reception/measurement of TRS 1-1 for reception of the DMRS for the PDSCH/channel estimation. In this case, the QCL source of the PDSCH is TRS 1-1, and a QCL target is the DMRS for the PDSCH.

### (Multi-TRP)

For NR, it is studied that one or a plurality of transmission/reception points (TRPs) (multi-TRP (multi TRP (MTRP))) perform DL transmission to a UE by using one or a plurality of panels (multi-panel). It is also studied that the UE performs UL transmission to the one or plurality of TRPs by using one or a plurality of panels.

Note that the plurality of TRPs may correspond to the same cell identifier (ID) or may correspond to different cell IDs. The cell ID may be a physical cell ID or a virtual cell ID.

The multi-TRP (for example, TRPs #1 and #2) may be connected via ideal/non-ideal backhaul to exchange information, data, and the like. Each TRP of the multi-TRP may transmit a different codeword (Code Word (CW)) and a different layer. As one mode of multi-TRP transmission, non-coherent joint transmission (NCJT) may be employed.

In NCJT, for example, TRP #1 performs modulation mapping on a first codeword, performs layer mapping, and transmits a first PDSCH in layers of a first number (for example, two layers) by using first precoding. TRP #2 performs modulation mapping on a second codeword, performs layer mapping, and transmits a second PDSCH in layers of a second number (for example, two layers) by using second precoding.

Note that a plurality of PDSCHs (multi-PDSCH) transmitted by NCJT may be defined to partially or entirely overlap in terms of at least one of the time and frequency domains. In other words, the first PDSCH from a first TRP and the second PDSCH from a second TRP may overlap in terms of at least one of the time and frequency resources.

The first PDSCH and the second PDSCH may be assumed not to be in a quasi-co-location (QCL) relationship (not to be quasi-co-located). Reception of the multi-PDSCH may be interpreted as simultaneous reception of PDSCHs of a QCL type other than a certain QCL type (for example, QCL type D).

A plurality of PDSCHs (which may be referred to as multi-PDSCH (multiple PDSCHs)) from the multi-TRP may be scheduled by using one piece of DCI (single DCI, single PDCCH) (single master mode, multi-TRP based on single DCI (single-DCI based multi-TRP)). The plurality of PDSCHs from the multi-TRP may be separately scheduled by using a plurality of pieces of DCI (multi-DCI, multi-PDCCH (multiple PDCCHs)) (multi-master mode, multi-TRP based on multi-DCI (multi-DCI based multi-TRP)).

For URLLC for multi-TRP, it is studied to support PDSCH (transport block (TB) or codeword (CW)) repetition over multi-TRP. It is studied to support a scheme of repetition over multi-TRP in the frequency domain, the layer (space) domain, or the time domain (URLLC schemes, for example, schemes 1, 2a, 2b, 3, and 4). In scheme 1, multi-PDSCH from multi-TRP is space division multiplexed (SDMed). In schemes 2a and 2b, PDSCHs from multi-TRP are frequency division multiplexed (FDMed). In scheme 2a, a redundancy version (RV) is the same for the multi-TRP. In scheme 2b, an RV may be the same or may be different for the multi-TRP. In schemes 3 and 4, multi-PDSCH from multi-TRP is time division multiplexed (TDMed). In scheme 3, multi-PDSCH from multi-TRP is transmitted in one slot. In scheme 4, multi-PDSCH from multi-TRP is transmitted in different slots.

According to such a multi-TRP scenario, more flexible transmission control using a channel with high quality is possible.

To support intra-cell (with the same cell ID) and inter-cell (with different cell IDs) multi-TRP transmission based on a plurality of PDCCHs, one control resource set (CORESET) in PDCCH configuration information (PDCCH-Config) may correspond to one TRP in RRC configuration information for linking a plurality of pairs of a PDCCH and a PDSCH with a plurality of TRPS.

When at least one of conditions 1 and 2 below is satisfied, the UE may determine that it is multi-TRP based on multi-DCI. In this case, a TRP may be interpreted as a CORESET pool index.

### {Condition 1}

One CORESET pool index is configured.

### {Condition 2}

Two different values (for example 0 and 1) of a CORESET pool index are configured.

When the following condition is satisfied, the UE may determine that it is multi-TRP based on single DCI. In this case, two TRPs may be interpreted as two TCI states indicated by a MAC CE/DCI.

### {Condition}

To indicate one or two TCI states for one codepoint of a TCI field in DCI, an “enhanced TCI states activation/deactivation for UE-specific PDSCH MAC CE” is used.

DCI for common beam indication may be a UE-specific DCI format (for example, DL DCI format (for example, 1_1, 1_2)), may be a UL DCI format (for example, 0_1, 0_2), or may be a UE-group common DCI format.

### (Unified/Common TCI Framework)

With a unified TCI framework, UL and DL channels can be controlled by a common framework. A unified TCI framework may indicate a common beam (common TCI state) and apply the common beam to all the UL and DL channels instead of defining a TCI state or a spatial relation for each channel as in Rel. 15, or apply a common beam for UL to all the UL channels while applying a common beam for DL to all the DL channels.

One common beam for both DL and UL or a common beam for DL and a common beam for UL (two common beams in total) are studied.

The UE may assume the same TCI state (joint TCI state, joint TCI pool, joint common TCI pool, joint TCI state set) for UL and DL. The UE may assume respective individual TCI states (separate TCI states, separate TCI pools, UL separate TCI pool and DL separate TCI pool, separate common TCI pools, UL common TCI pool and DL common TCI pool) for UL and DL.

By beam management based on a MAC CE (MAC CE level beam indication), default UL and DL beams may be aligned. A default TCI state of a PDSCH may be updated to match to a default UL beam (spatial relation).

By beam management based on DCI (DCI level beam indication), a common beam/unified TCI state may be indicated from the same TCI pool (joint common TCI pool, joint TCI pool, set) for both UL and DL. X (>1) TCI states may be activated by a MAC CE. UL/DL DCI may select one from the X active TCI states. The selected TCI state may be applied to channels/RSs of both UL and DL.

The TCI pool (set) may be a plurality of TCI states configured by an RRC parameter or a plurality of TCI states (active TCI states, active TCI pool, set) activated by a MAC CE among the plurality of TCI states configured by the RRC parameter. Each TCI state may be a QCL type A/D RS. As the QCL type A/D RS, an SSB, a CSI-RS, or an SRS may be configured.

The number of TCI states corresponding to each of one or more TRPs may be defined. For example, the number N (≥1) of TCI states (UL TCI states) applied to UL channels/RSs and the number M (≥1) of TCI states (DL TCI states) applied to DL channels/RSs may be defined. At least one of N and M may be notified/configured/indicated to the UE via higher layer signaling/physical layer signaling.

In the present disclosure, description of N=M=X (X is any integer) may mean that X TCI states (joint TCI states) (corresponding to X TRPs) common to the UL and the DL are notified/configured/indicated to the UE.

Description of N=X (X is any integer) and M=Y (Y is any integer and Y may be equal to X) may mean that X UL TCI states (corresponding to X TRPs) and Y DL TCI states (corresponding to Y TRPs) are notified/configured/indicated to the UE. The UL TCI state and the DL TCI state may mean a TCI state (that is, a joint TCI state) common to the UL and the DL, or may mean a TCI state (that is, a separate TCI state) of each of the UL and the DL.

For example, description of N=M=1 may mean that one TCI state common to the UL and the DL for a single TRP is notified/configured/indicated to the UE (joint TCI state for a single TRP).

For example, description of N=1 and M=1 may mean that one UL TCI state and one DL TCI state for a single TRP are separately notified/configured/indicated to the UE (separate TCI states for a single TRP).

For example, description of N=M=2 may mean that a plurality of (two) TCI states common to the UL and the DL for a plurality of (two) TRPs are notified/configured/indicated to the UE (joint TCI states for a plurality of TRPs).

For example, description of N=2 and M=2 may mean that a plurality of (two) UL TCI states and a plurality of (two) DL TCI states for a plurality of (two) TRPs are notified/configured/indicated to the UE (separate TCI states for a plurality of TRPs).

For example, description of N=2 and M=1 may mean that two TCI states common to the UL and the DL are notified/configured/indicated to the UE. In this case, the UE may use the two configured/indicated TCI states as the UL TCI state, and use one TCI state out of the two configured/indicated TCI states as the DL TCI state.

For example, description of N=2 and M=1 may mean that two UL TCI states and one DL TCI state are notified/configured/indicated to the UE as the separate TCI state.

Note that, although the above examples describe cases in which the value of N and M is 1 or 2, the value of N and M may be 3 or greater, and N and M may be different from each other.

A case of M>1/N>1 may indicate at least one of a TCI state indication for a plurality of TRPs and a plurality of TCI state indications for inter band CA.

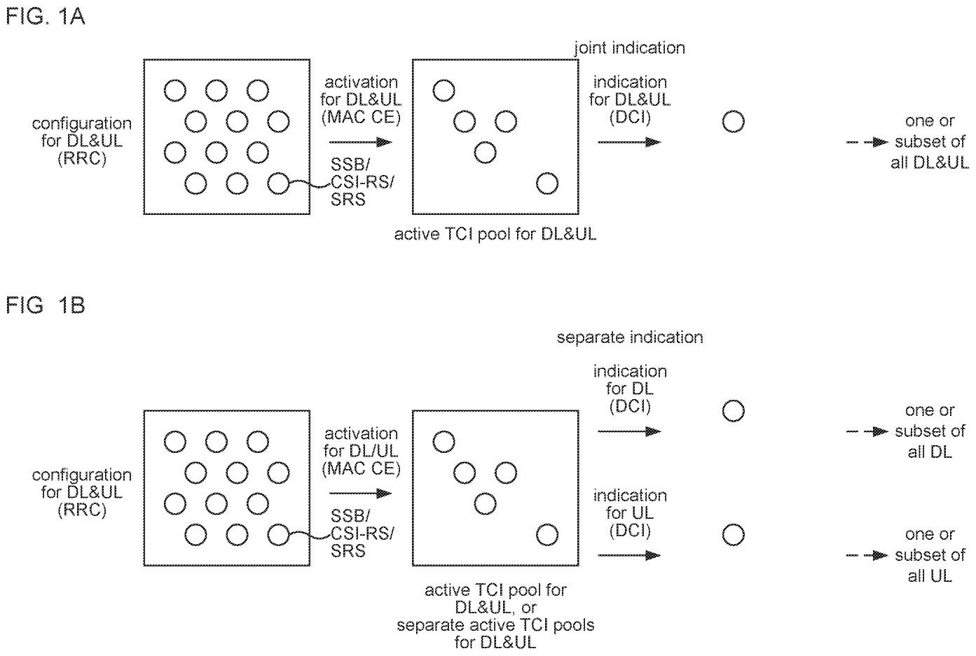

In the example in FIG. 1A, an RRC parameter (information element) configures a plurality of TCI states for both DL and UL. The MAC CE may activate a plurality of TCI states among the plurality of configured TCI states. DCI may indicate one of the plurality of activated TCI states. The DCI may be UL/DL DCI. The indicated TCI state may be applied to at least one (or all) of UL/DL channels/RSs. One piece of DCI may indicate both a UL TCI and a DL TCI.

In the example in FIG. 1A, one dot may be one TCI state applied to both UL and DL or may be two respective TCI states applied to UL and DL.

At least one of the plurality of TCI states configured by the RRC parameter and the plurality of TCI states activated by the MAC CE may be referred to as a TCI pool (common TCI pool, joint TCI pool, TCI state pool). The plurality of TCI states activated by the MAC CE may be referred to as an active TCI pool (active common TCI pool).

Note that, in the present disclosure, a higher layer parameter (RRC parameter) that configures a plurality of TCI states may be referred to as configuration information that configures a plurality of TCI states or simply as “configuration information.” In the present disclosure, one of a plurality of TCI states being indicated by using DCI may be receiving indication information indicating one of a plurality of TCI states included in DCI or may simply be receiving “indication information.”

In the example in FIG. 1B, an RRC parameter configures a plurality of TCI states for both DL and UL (joint common TCI pool). A MAC CE may activate a plurality of TCI states (active TCI pool) among the plurality of configured TCI states. Respective (different, separate) active TCI pools for UL and DL may be configured/activated.

DL DCI or a new DCI format may select (indicate) one or more (for example, one) TCI states. The selected TCI state(s) may be applied to one or more (or all) DL channels/RSs. The DL channel(s) may be a PDCCH/PDSCH/CSI-RS(s). The UE may determine the TCI state of each of the DL channels/RSs by using operation of a TCI state (TCI framework) of Rel. 16. UL DCI or a new DCI format may select (indicate) one or more (for example, one) TCI states. The selected TCI state(s) may be applied to one or more (or all) UL channels/RSs. The UL channel(s) may be a PUSCH/SRS/PUCCH(s). Thus, different pieces of DCI may indicate a UL TCI and a DL DCI separately.

Existing DCI format 1_1/1_2 may be used for indication of a common TCI state.

A common TCI framework may include separate TCI states for DL and UL.

### (Analysis)

### <TCI State and QCL Information in Rel. 16>

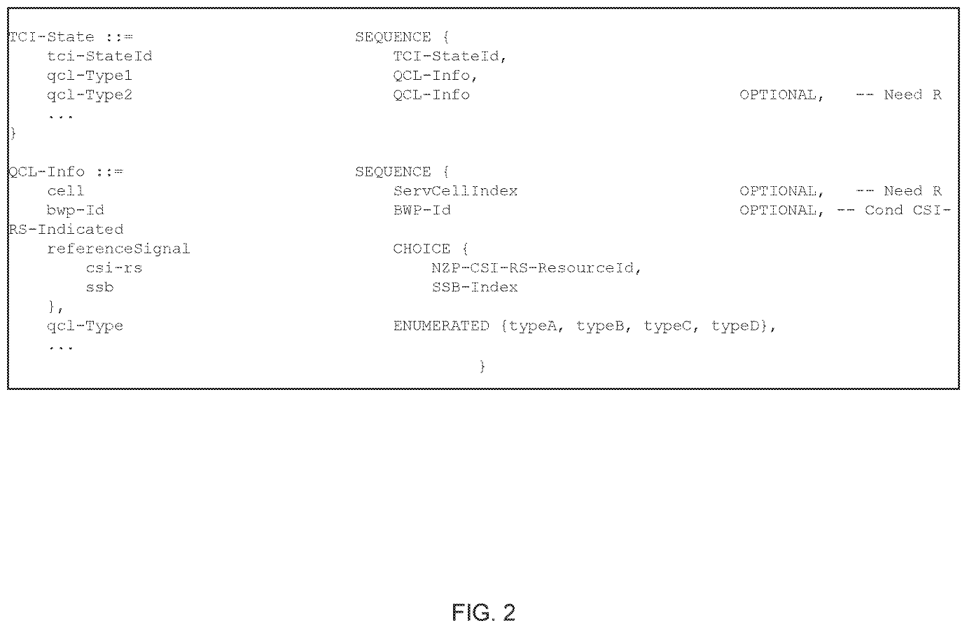

FIG. 2 is a Diagram to Show an RRC Configuration of a TCI state and QCL information in Rel. 16. As the TCI state, a TCI state ID (tci-StateId) and QCL types 1 and 2 (qcl-Type1, 2) are configured. The QCL information (QCL-Info) corresponds to each of QCL types 1 and 2. The QCL information includes a cell, a BWP ID (bwp-Id), a reference signal (referenceSignal) (csi-rs, ssb), and a QCL type.

In a unified TCI state configuration of Rel. 17, it has been studied that a joint/separate DL/UL TCI state indication using a MAC CE/DCI supports a case of M=N=1. It has been studied that inter-cell beam management is also supported in Rel. 17. For example, the TCI state may correspond to an SSB of a different PCI.

### <CSI Report in Rel. 16>

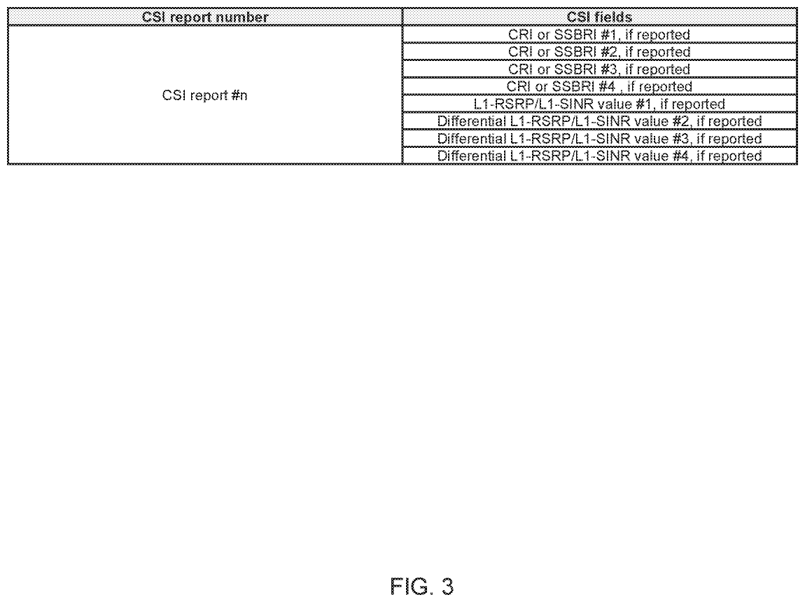

FIG. 3 is a diagram to show a CSI report in Rel. 16. As shown in FIG. 3, the CSI report includes a CRI or an SSBRI, an L1-RSRP/L1-SINR value, and a Differential L1-RSRP/L1-SINR/value.

In Rel. 17, it has been studied that CSI (L1 beam) report/measurement is enhanced. For example, in order to enhance a function of a DL L1 beam report in inter-cell beam management, report/measurement of an L1 beam for a cell including a different PCI has been studied. In order to enhance a function of a DL group based L1 beam report in multi-TRP beam management of Rel. 17, the UE may receive up to four beam groups (two beams in each group) and simultaneously receive the beams in the groups. In order to enhance a function of a UL L1 beam report of Rel. 17 for addressing a maximum permitted exposure (MPE) problem in the UL, a power management maximum power reduction (P-MPR) value may be added in the SSBRI/CRI of a Power Headroom Report (PHR) MAC CE.

### <Assumption 1>

In Assumption 1, a joint DL/UL TCI state is applied, and the number of M and N is one of M=N=1, M=2 and N=1, M=1 and N=2, and M=2 and N=1.

When the joint DL/UL TCI state is applied, the following may be considered: with reuse of the DL L1 beam report, an activated joint DL/UL TCI state recommended by the UE is indicated.

### <Assumption 2>

In Assumption 2, a separate DL/UL TCI state is applied, and the number of M and N is one of M=N=1, M=2 and N=1, M=1 and N=2, and M=2 and N=1.

In a case of the separate DL/UL TCI state, a DL/UL active beam/TCI state needs to be separately updated.

A detailed design of activation of a TCI state when at least one of Assumption 1 (joint TCI state) and Assumption 2 (separate TCI state) is applied has not been clarified. For example, configuration from the base station, report by the UE, or the like has not been clarified. This may cause reduction of communication throughput, without an appropriate TCI state being activated.

In view of this, the inventors of the present invention came up with the idea of a method for enabling activation of an appropriate TCI state.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C”.

In the present disclosure, activate, deactivate, indicate, select, configure, update, determine, report, and the like may be interchangeably interpreted. In the present disclosure, “support,” “control,” “controllable,” “operate,” “operable”, and the like may be interchangeably interpreted.

In the present disclosure, radio resource control (RRC), an RRC parameter, an RRC message, a higher layer parameter, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, or a PUCCH resource group), a resource (for example, a reference signal resource or an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, a quasi-co-location (QCL), a QCL assumption, and the like may be interchangeably interpreted.

In the present disclosure, a beam, a spatial domain filter, a space setting, a TCI state, a UL TCI state, a unified TCI state, a unified beam, a common TCI state, a common beam, a TCI assumption, a QCL assumption, a QCL parameter, a spatial domain reception filter, a UE spatial domain reception filter, a UE receive beam, a DL beam, a DL receive beam, DL precoding, a DL precoder, a DL-RS, an RS of QCL type D of a TCI state/QCL assumption, an RS of QCL type A of a TCI state/QCL assumption, spatial relation, a spatial domain transmission filter, a UE spatial domain transmission filter, a UE transmit beam, a UL beam, a UL transmit beam, UL precoding, a UL precoder, and a PL-RS may be interchangeably interpreted. In the present disclosure, a QCL type X-RS, a DL-RS associated with QCL type X, a DL-RS having OCL type X, a source of a DL-RS, an SSB, a CSI-RS, and an SRS may be interchangeably interpreted.

In the present disclosure, a multi-TRP, a channel using a multi-TRP, a channel using a plurality of TCI states/spatial relations, enabling of a multi-TRP by RRC/DCI, enabling of a plurality of TCI states/spatial relations by RRC/DCI, and at least one of a multi-TRP based on single DCI and a multi-TRP based on multi-DCI may be interchangeably interpreted. In the present disclosure, a multi-TRP based on multi-DCI and configuration of one CORESET pool index (CORESETPoolIndex) value for the CORESET may be interchangeably interpreted. In the present disclosure, a multi-TRP based on single DCI and mapping of at least one codepoint of a TCI field to two TCI states may be interchangeably interpreted.

In the present disclosure, a single DCI (SDCI), a single PDCCH, a single-DCI based multi-TRP system, an sDCI based MTRP, and activation of two TCI states in at least one TCI codepoint may be interchangeably interpreted.

In the present disclosure, a multi-DCI (mDCI), a multi-PDCCH, a multi-DCI based multi-TRP system, an mDCI based MTRP, and configuration of two CORESET pool indices or CORESET pool index=1 (or one or more values) may be interchangeably interpreted.

In the present disclosure, description of “Rel. XX” indicates a release number of 3GPP. Note that the number “XX” is an example, and may be replaced with another number.

In the present disclosure, an L1 beam report, a beam report, and a CSI report may be interchangeably interpreted. Report, measure, and indicate may be interchangeably interpreted. To activate/deactivate a TCI state and to update a TCI state may be interchangeably interpreted.

### (Radio Communication Method)

In the following, regarding first to fifth embodiments, Assumption 1 is presupposed in which the same TCI state (joint DL/UL TCI state) is applied to the DL and the UL. Regarding sixth to twelfth embodiments, Assumption 2 is presupposed in which a separate TCI state (separate DL/UL TCI state) is applied to each of the DL and the UL.

### First Embodiment

When the same TCI state (joint DL/UL TCI state) is applied to the DL and the UL, the UE may receive a specific configuration for enabling/disabling initiation of activation/deactivation of a TCI state by the UE from the base station, using RRC/MAC CE/DCI. The specific configuration may be a configuration for each case (a combination of M and N), or one configuration may correspond to a plurality of cases. When the UE receives the configuration, the UE may initiate activation of the TCI state. A function of activation/deactivation of a TCI state initiated by the UE may be referred to as a specific function. Activation/deactivation of a TCI state may indicate update of an active TCI state.

“Initiate”, “control”, “determine”, “report”, and “trigger by an event” may be interchangeably interpreted. An event (condition) for activating/reporting a beam/TCI state may be defined in a specification in advance, or may be configured/indicated by higher layer signaling/physical layer signaling. For example, the event is an event in which the current beam strength becomes worse than strength of another beam.

The UE may transmit a specific report indicating whether to enable/disable initiation of activation of a TCI state by the UE, using an RRC IE/MAC CE/UCI/Random Access Channe (RACH) (Contention based Random Access (CBRA)/Contention-Free Random Access (CFRA))/Scheduling Request (SR).

### [Option 1-1]

The UE may transmit the specific report separately from other information. For example, the UE may transmit a new MAC CE indicating that the specific function is enabled/disabled.

### [Option 1-2]

The UE may transmit the specific report together with information indicating a recommended beam. For example, the recommended beam may be the best (strongest) beam determined based on beam strength (for example, RSRP or SINR) and the like. For example, the UE may add the specific report (representation, indication, field) to an existing L1 beam report, and thereby indicate whether or not a reported L1 beam is for the use of update of an active TCI state (whether or not it is used for update/indication of an active TCI state).

### [Option 1-3]

The UE may transmit the specific report together with information indicating a recommended TCI state. For example, the UE may transmit a new report including the specific report and the recommended TCI state. The new report may indicate whether or not the recommended TCI state is for the use of update of an active TCI state (whether or not it is used for update/indication of an active TCI state). The recommended TCI state may correspond to the recommended beam. Thus, a method of determining the recommended TCI state may be similar to a method of determining the recommended beam.

### [Option 1-4]

The UE may transmit implicit information corresponding to the specific report, without transmitting the specific report as explicit information. For example, the UE may transmit only the recommended TCI state. The reported recommended TCI state may mean that it is for the use of update of an active TCI state (it is used for update of an active TCI state). For example, the UE may transmit only the L1 beam report. The reported L1 beam report may mean that it is for the use of update of an active TCI state (it is used for update of an active TCI state).

Note that only one of the specific configuration by the base station (for example, a gNB) and the specific report by the UE described above may be supported, or both of these may be supported. When both of these are supported, the specific report by the UE may conform to the specific configuration transmitted by the base station.

According to the present embodiment, by initiating activation/deactivation of a TCI state, the UE can activate an appropriate TCI state.

### Second Embodiment

The UE may update i (first number) active TCI states to p (second number) new active TCI states, based on the DL L1 beam report (CSI report) (for example, j beam reports). i may be equal to p (for example, p=i), or may be different from p. For example, p may be equal to j. i and j in each embodiment may be numerical values different from M and N indicated in the above Unified/Common TCI Framework, or may be the same numerical values.

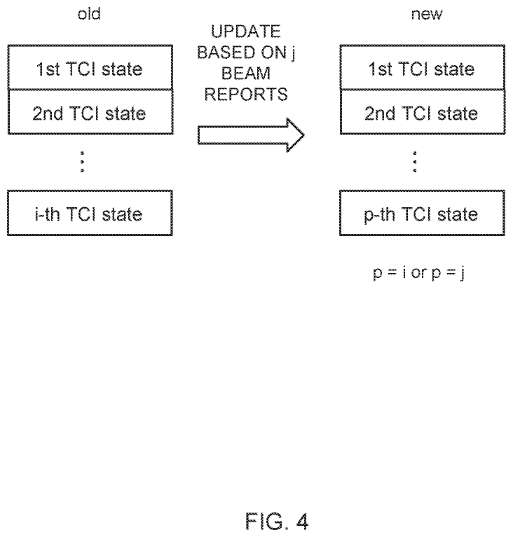

FIG. 4 is a diagram to show an example of update of TCI states according to a second embodiment. As shown in FIG. 4, i TCI states are updated to p active TCI states, based on j beam reports. p may be equal to i, or p may be equal to j. For example, a 1st TCI state is the best TCI state (for example, the TCI state corresponding to the largest L1-RSRP/SINR value). Note that the best TCI state may be the same as the recommended TCI state described above.

The UE may update i active TCI states so as to be respectively associated with i beams. For example, the UE may update a 1st/last TCI state so as to be associated with a 1st beam (SSB/CSI-RS), update a 2nd TCI state/a 2nd TCI state from the last so as to be associated with a 2nd beam (SSB/CSI-RS), and update a k-th/(i−k+1)-th TCI state so as to be associated with a k-th beam (SSB/CSI-RS). The SSB and the SSBRI may be interchangeably interpreted. The CSI-RS and the CRI may be interchangeably interpreted.

Regarding a method for updating the original i TCI states configured in QCL type 1 (qcl-Type1)/QCL type 2 (qcl-Type2), at least one of the following Options 2-1-1 to 2-1-3 may be applied. For example, the Reference Signal (RS) in the present disclosure may be the SSB/CSI-RS.

### [Option 2-1-1]

The UE may update the RS in both of QCL type 1 and QCL type 2 of the TCI state (if both of the RSs are present).

### [Option 2-1-2]

The UE may update the RS in one of QCL type 1 and QCL type 2 of the TCI state. The RS may be accompanied by a specific QCL type. The specific QCL type may be the QCL type D, or may be another QCL type.

### [Option 2-1-3]

Although the UE does not update the RS corresponding to i TCI states, the UE may search for and find (determine/identify) TCI states from a TCI pool configured using RRC. For example, the UE may search for and find (determine/identify) up to j TCI states having a QCL relationship with reported beams from the TCI pool configured using RRC.

Next, update of the TCI state for each relationship between i, p, and j will be described (in a case of Option 2-1-1/2-1-2).

[i≥ j]

First/last j active TCI states may be updated to new RSs/beams, and the rest of (i-j) TCI states may remain activated and need not be updated (p=i). Alternatively, the first/last j active TCI states may be updated to new RSs/beams, and the rest of (i-j) TCI states may be deactivated (p=j).

[i<j]

i active TCI states may be updated to new RSs/beams (p=i) or i active TCI states may be updated to new RSs/beams, and additional (j−i) TCI states may also be activated (p=j).

According to the present embodiment, regardless of the number of active TCI states, the UE can appropriately update the active TCI states.

### Third Embodiment

The UE may update i (first number) active TCI states to p (second number) new active TCI states, based on a new report of the recommended TCI state. The TCI states may be j TCI states, and may be, for example, the TCI states in Options 1-3 and 1-4 of the first embodiment.

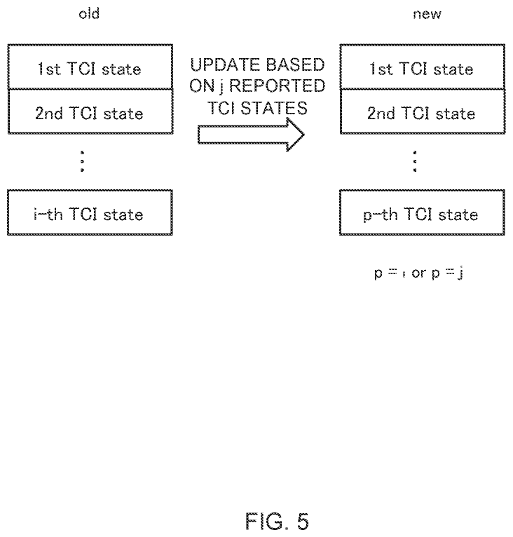

FIG. 5 is a diagram to show an example of update of TCI states according to a third embodiment. As shown in FIG. 5, i TCI states are updated to p active TCI states, based on j reported TCI states. p may be equal to i, or p may be equal to j. For example, a 1st TCI state is the best TCI state (for example, the TCI state corresponding to the largest L1-RSRP/SINR value).

The UE may perform the new report, using an RRC IE/MAC CE/UCI. When a MAC CE is used, a configuration of the MAC CE may be similar to an existing configuration of the MAC CE related to activation/deactivation of TCI states of the PDSCH.

The new report may be a P/SP/AP-CSI report (for example, an L1 beam) or an event triggered beam report. In the present disclosure, a beam report based on an event, a beam report based on occurrence of an event, a beam report triggered by an event, and an event triggered beam report (Event triggered beam reporting) may be interchangeably interpreted.

The UE may transmit (report) the new report separately from an existing (another) report, or may transmit (report) the new report together with an existing (another) report.

Regarding update of the TCI states in the present embodiment, one of the following Options 3-1 and 3-2 may be applied.

### [Option 3-1]

The UE may update j reported TCI states as active TCI states (p=j). For example, the UE may update a 1st reported TCI state as a 1st active TCI state.

### [Option 3-2]

The UE may replace a 1st TCI state/last TCI state out of the i TCI states based on a 1st reported TCI state, replace a 2nd TCI state/a 2nd TCI state from the last out of the i TCI states based on a 2nd reported TCI state, and replace a k-th/(i−k+1)-th TCI state based on a k-th reported TCI state (p=i). For example, in the case of i<j, only the i TCI states are replaced. In the case of i≥j, the rest of (i−j) TCI states may remain active states and need not be updated.

According to the present embodiment, regardless of the number of active TCI states, the UE can appropriately update the active TCI states.

### Fourth Embodiment

Regarding a timing (timeline) at which the UE applies P updated active TCI states, at least one of the following Options 4-1 to 4-3 may be applied.

### [Option 4-1]

As with the second/third embodiment, the timing may be a specific period (for example, x slots/mini-slots/symbols) later than a timing at which the UE transmits a beam report/TCI state report (x=0 or x>0).

### [Option 4-2]

When the UE transmits the PUSCH for transmitting a beam report/TCI state report as in the second/third embodiment, the timing may be a specific period (for example, x slots/mini-slots/symbols) later than a timing at which an ACK for the PUSCH is received. For example, x may be the number of symbols from the last symbol in reception of the PDCCH having a specific DCI format. The specific DCI format schedules PUSCH transmission corresponding to the same HARQ process number as the HARQ process number for first PUSCH transmission for transmitting a beam/TCI state report, and has a toggled NDI field field value.

### [Option 4-3]

The timing may be a specific period (for example, x slots/mini-slots/symbols) later than a timing at which the UE receives a response from the base station for confirmation. For example, the response is a new MAC CE, new DCI (for example, DCI having a new field, DCI of a specific DCI format, DCI having a specific RNTI, or the like), or a new beam indication (activation/indication of a TCI state or the like).

According to the present embodiment, updated active TCI states can be applied at an appropriate timing.

### Fifth Embodiment

After update of TCI states, when the number P of active TCI states is more than one (P>1), information indicating one TCI state out of the P active TCI states is received using DCI for beam indication of any channel (PDCCH/PDSCH/PUCCH/PUSCH or the like). For example, when P=1 and M=N=1, the active TCI states are indicated TCI states.

A case other than M=N=1 (for example, M=1 and N=2, M=2 and N=1, and M=2 and N=2) will be described.

[PDSCH/PUSCH from Single-DCI Based Multi-TRP]

When the single-DCI based multi-TRP is applied, i unupdated active TCI states corresponding to the PDSCH/PUSCH may be i sets of TCI states activated by a MAC CE, and each set may include one or two TCI states.

When the example of the second embodiment is applied, the UE may update the two TCI states of each set, using two beams in each group in a group based beam report. The UE may update one TCI state in each set, using a beam of a non-group based beam report.

Alternatively, when the example of the second embodiment is applied, the UE may use two separate non-group based beam reports. The UE may update a 1st TCI state in each set based on a 1st beam report, and update a 2nd TCI state in each set based on a 2nd beam report.

When the example of the third embodiment is applied, the UE may report p sets of TCI states, using RRC/MAC CE/UCI. In each set, one or two TCI states may be present. [PDSCH/PUSCH from Multi-DCI Based Multi-TRP]

When the multi-DCI based multi-TRP is applied, i active TCI

states corresponding to the PDSCH/PUSCH are updated/configured for each CORESET pool index. For example, in all of the TRPs, up to 2i active TCI states are updated/configured.

When the example of the second embodiment is applied, the UE may update TCI states corresponding to respective CORESET pool indices, using two beams in each group from the group based beam report.

Alternatively, when the example of the second embodiment is applied, two separate non-group based beam reports may be used. The UE may update TCI states corresponding to the CORESET pool indices, based on respective beam reports.

When the example of the third embodiment is applied, the UE may report p TCI states corresponding to respective CORESET pool indices, using RRC/MAC CE/UCI. For example, up to 2p TCI states are reported to all of the TRPs. The 2p TCI states may be included in one report, or may be included in separate reports corresponding to different TRPS.

According to the present embodiment, even when the multi-TRP is applied, active TCI states can be appropriately indicated.

### Sixth Embodiment

With application of Assumption 2 described above, processing similar to that of the first embodiment may be applied. When a separate TCI state (separate DL/UL TCI state) is applied to each of the DL and the UL, the UE may receive a specific configuration for enabling/disabling initiation of activation/deactivation of a DL/UL TCI state by the UE from the base station, using RRC/MAC CE/DCI. Initiation may be interpreted as determination/report. When the UE receives the configuration, the UE may initiate activation of the TCI state.

The UE may transmit a specific report indicating whether to enable/disable initiation of activation of a UL/DL TCI state by the UE, using an RRC IE/MAC CE/UCI/RACH (CBRA/CFRA)/SR. Differences between the processing of the present embodiment to which Assumption 2 is applied and the processing of the first embodiment will be mainly described below.

### [Option 6-1]

For the UE, for activation of a DL/UL TCI state, configuration/indication by the base station and report by the UE may be separately performed regarding the DL/UL. For example, the configuration/indication by the base station is the specific configuration of the first embodiment. For example, the report by the UE may be the specific report of the first embodiment or the report in the second/third embodiment. Regarding the DL beam/TCI state and the UL beam/TCI state, the UE may transmit different reports, or may transmit reports of different formats/signaling designs. For a DL beam/TCI state report, the second/third embodiment may be used. Note that, for a UL beam/TCI state report, a seventh/eighth embodiment to be described later may be applied.

### [Option 6-2]

There may be one configuration/indication by the base station and one report by the UE for activation of (both of) DL/UL TCI states. When the UE reports beams/TCI states, the UE may transmit both of a DL beam/TCI state and a UL beam/TCI state as one report. For example, a ninth/tenth embodiment to be described later may be applied.

According to the present embodiment, even when the separate DL/UL TCI state is applied, by initiating activation/deactivation of a TCI state, the UE can activate an appropriate TCI state.

### Seventh Embodiment

The UE may update i (first number) UL active TCI states to p (second number) new UL active TCI states, based on at least one of a UL L1 beam report (CSI report), a PHR, and an MPE report (for example, corresponding to j UL beams).

A “PHR”, a “PH”, a “PH field”, and a “PH value” may be interchangeably interpreted. MPE, MPR, and P-MPR may be interchangeably interpreted. The UE may update a TCI state whose PH value corresponds to the largest beam to an active TCI state. The UE may update a TCI state corresponding to a beam meeting MPE requirements to an active TCI state.

For example, the UE may transmit the UL L1 beam report, using a CSI report framework, or may transmit the UL L1 beam report together with the PHR/MPE, using a MAC CE.

The UE may report (transmit) information indicating beams (MPE safe beams) meeting the MPE requirements and the MAC CE or the like, based on a configuration of beam measurement. Then, the UE may select a beam to be used, out of the beams meeting the MPE requirements. The MPE safe beam may be referred to as an MPE adapted beam. Measurement/report related to the MPE safe beam may be referred to as MPE safe beam measurement/report or new beam measurement/report.

When the UE determines a beam not functioning for MPE (having the MPE problem, not meeting the MPE requirements) and it is determined that a selected beam (for example, a beam indicated by an indication from the base station) does not meet the MPE requirements, the UE may re-select (re-determine) a beam to be used, based on a value based on the MPE requirements.

A UL beam report configuration and a DL beam report configuration may be separate. For example, the UE may receive a first information element including the UL beam report configuration and a second CSI information element including the DL beam report configuration, which is different from the first information element, using higher layer signaling. For example, the information element is a CSI report configuration.

Alternatively, the UE may receive the DL beam report configuration together with the UL beam report configuration (joint beam measurement/report configuration for the UL and the DL). For example, the UE may receive one information element including both of the UL beam report configuration and the DL beam report configuration, using higher layer signaling. The UL beam report may be supported in addition to the DL beam report (for example, L1-RSRP or L1-SINR). In other words, the UL beam report may be configured only when the DL beam report is configured.

Regarding a method of updating from i TCI states to p TCI states based on j UL beams, the second embodiment may be reused, with Assumption 2 being presupposed.

According to the present embodiment, an appropriate TCI state can be activated by taking the L1 beam report (CSI report), the PHR, and the MPE report into consideration.

### Eighth Embodiment

The UE may update i (first number) active UL TCI states to p (second number) new active UL TCI states, based on (for example, j) new reports of UL recommended TCI states.

The UE may perform the new report, using an RRC IE/MAC CE/UCI. When a MAC CE is used, a configuration of the MAC CE may be similar to an existing configuration of the MAC CE related to activation/deactivation of TCI states of the PDSCH.

The new report may be a P/SP/AP-CSI report (for example, an L1 beam) or an event triggered beam report. In the present disclosure, a beam report based on an event, a beam report based on occurrence of an event, a beam report triggered by an event, and an event triggered beam report (Event triggerd beam reporting) may be interchangeably interpreted.

The UE may transmit (report) the new report separately from an existing (another) report, or may transmit (report) the new report together with an existing (another) report.

In the processing of the present embodiment, the third embodiment may be reused, with Assumption 2 being presupposed. According to the present embodiment, regardless of the number of active TCI states, the UE can appropriately update the active TCI states.

### Ninth Embodiment

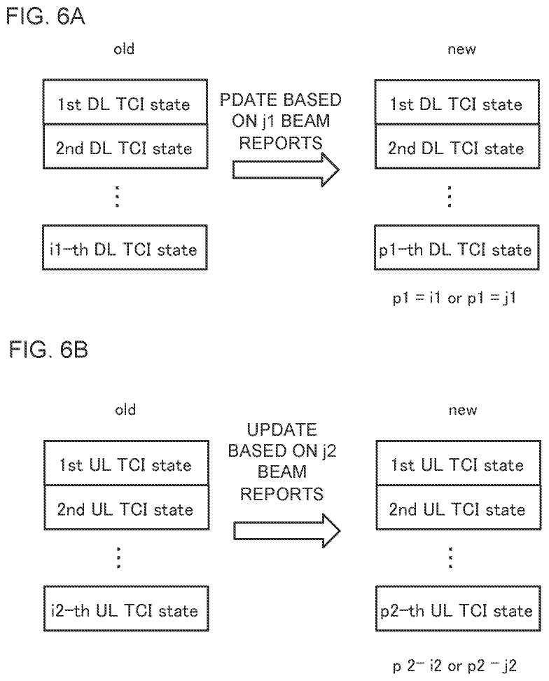

Based on the DL L1 beam report (corresponding to j1 beams) and the UL L1 beam report (corresponding to j2 beams) transmitted as one report, the UE may update i1 active DL TCI states to p1 new active DL TCI states (see FIG. 6A) and update i2 active UL TCI states to p2 new active UL TCI states (see FIG. 6B). i1 may be equal to p1 (p1=i1), or may be different from p1 (for example, p1=j1). i2 may be equal to p2 (p2=12), or may be different from p2 (for example, p2=j2).

In the processing of the present embodiment, the second embodiment may be reused, with Assumption 2 being presupposed. In this case, the TCI state of the second embodiment may be interpreted as at least one of the DL TCI state and the UL TCI state.

According to the present embodiment, regardless of the number of active TCI states, the UE can appropriately update the active TCI states.

### Tenth Embodiment

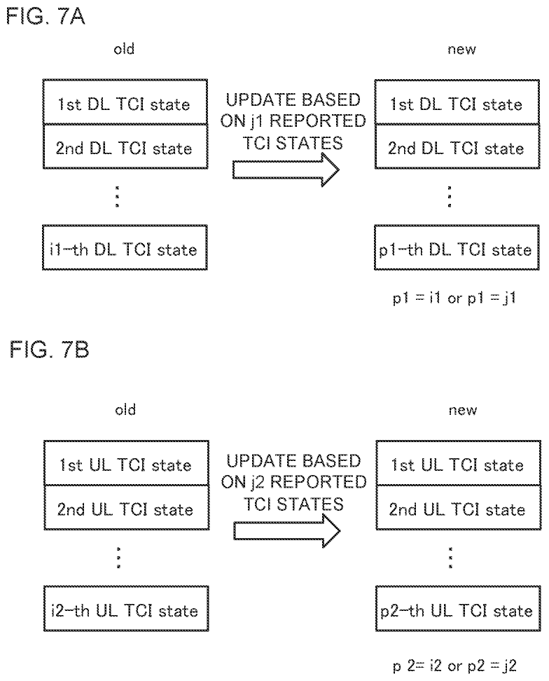

Based on the DL TCI state report (corresponding to j1 TCI states) and the UL TCI state report (corresponding to j2 TCI states) transmitted as one report using an RRC IE/MAC CE/UCI, the UE may update i1 active DL TCI states to p1 new active DL TCI states (see FIG. 7A) and update i2 active UL TCI states to p2 new active UL TCI states (see FIG. 7B). i1 may be equal to p1 (p1=i1), or may be different from p1 (for example, p1=j1). i2 may be equal to p2 (p2=i2), or may be different from p2 (for example, p2=j2). The reported DL TCI state and UL TCI state may be a recommended DL TCI state or a recommended UL TCI state.

In the processing of the present embodiment, the third embodiment may be reused, with Assumption 2 being presupposed. In this case, the TCI state of the third embodiment may be interpreted as at least one of the DL TCI state and the UL TCI state.

Regarding j1 DL TCI states and j2 UL TCI states, the UE may report each of the TCI state corresponding to both of the DL and the UL, the TCI state corresponding to only the DL, and the TCI state corresponding to only the UL.

According to the present embodiment, regardless of the number of active TCI states, the UE can appropriately update the active TCI states.

### Eleventh Embodiment

When report and activation of the separate DL/UL TCI state are applied, the fourth embodiment may be applied to each of the DL TCI state and the UL TCI state. When the DL/UL beam/TCI states are reported in one report, the fourth embodiment may be simultaneously applied to the DL beam/TCI state and the UL beam/TCI state.

According to the present embodiment, updated active TCI states can be applied at an appropriate timing.

### Twelfth Embodiment

With application of the separate TCI state, an example of a case other than M=N=1 (for example, M=1 and N=2, M=2 and N=1, and M=2 and N=2) will be described.

[PDSCH/PUSCH from Single-DCI Based Multi-TRP]

When M=2, i1 unupdated active DL TCI states may be i1 sets of DL TCI states activated by a MAC CE, and one or two TCI states may correspond to each set.

When N=2, 12 unupdated active UL TCI states may be i2 sets of UL TCI states being active by a MAC CE, and one or two TCI states may correspond to each set.

[PDSCH/PUSCH from Multi-DCI Based Multi-TRP]

In a case of the multi-DCI based multi-TRP, i1 active DL TCI states or i2 active UL TCI states corresponding to the PDSCH/PUSCH are updated/configured for each CORESET pool index. For example, in all of the TRPs, up to 211 active DL TCI states or up to 212 active UL TCI states are updated/configured.

With Assumption 2 being presupposed, the fifth embodiment may be reused. In that case, the TCI state of the fifth embodiment may be at least one of the UL TCI state and the DL TCI state.

According to the present embodiment, even when the multi-TRP is applied, active TCI states can be appropriately indicated.

### <UE Capability>

The UE may transmit (report) UE capability information indicating whether to support at least one of the examples in the present disclosure to a network (base station). At least one of the examples in the present disclosure may be applied only to the UE that has transmitted specific UE capability information or the UE that supports the specific UE capability. The UE may receive information indicating at least one of the examples in the present disclosure, using higher layer signaling/physical layer signaling. The information may correspond to the UE capability information transmitted by the UE. The UE capability information may be at least one of the following (1) to (5), for example.
(1) When at least one of the joint/separate DL/UL TCI state, various values of M and N, and the single-DCI/multi-DCI multi-TRP case is applied, whether the UE supports activation of the DL/UL TCI state to be initiated.
(2) Whether to support the configuration (for example, the configuration using RRC/MAC CE/DCI) by the base station (for example, the gNB) in the present disclosure.
(3) Whether to support at least one of the report/indication by the UE in the present disclosure.
(4) Whether the UE reports a recommended DL/UL TCI state, using RRC/MAC CE/UCI. Whether the report is a P/SP/AP CSI report or an event triggered beam report. In a case of the separate DL/UL TCI, whether to perform one report or perform separate reports regarding the DL/UL.
(5) Limitation on i, p, and j (in a case of the joint DL/UL TCI) and i1, p1, j1, i2, p2, and j2 (in a case of the separate DL/UL TCI). For example, P≤8, P<M, P<N, N≤4 or 8, and the like.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

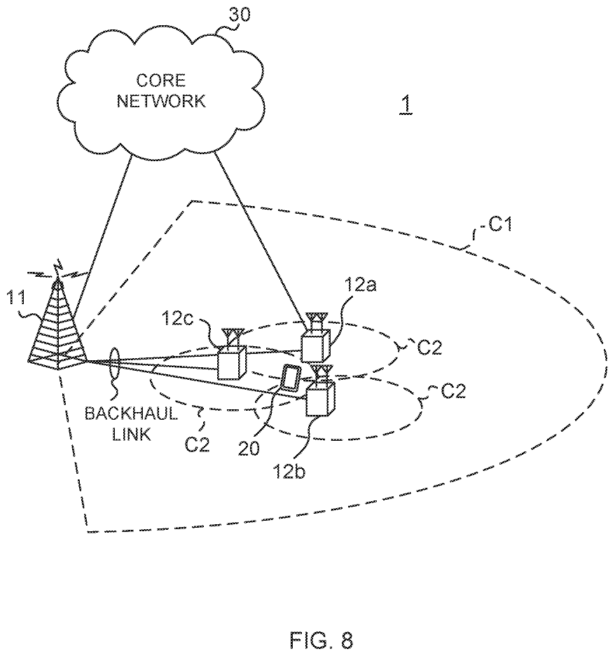

FIG. 8 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

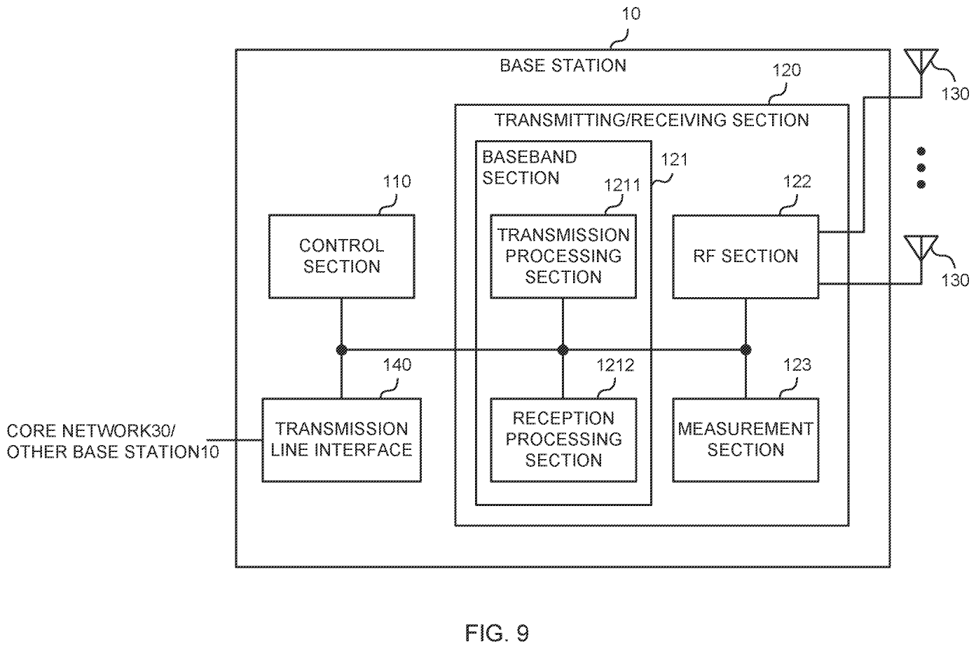

FIG. 9 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmitting/receiving section 120 may, when the same Transmission Configuration Indication (TCI) state is applied to a downlink (DL) and an uplink (UL), transmit a specific configuration for enabling or disabling initiation of activation of the TCI state by a UE. The control section 110 may control transmission and reception, based on the TCI state whose activation is initiated by a terminal. The transmitting/receiving section 120 may receive a specific report indicating whether to enable or disable initiation of activation of the TCI state by the UE.

The transmitting/receiving section 120 may, when a separate Transmission Configuration Indication (TCI) state is applied to each of a downlink (DL) and an uplink (UL), transmit a specific configuration for enabling or disabling initiation of activation of the TCI state of at least one of the UL and the DL by a UE. The control section 110 may control transmission and reception, based on the TCI state whose activation is initiated by a terminal.

### (User Terminal)

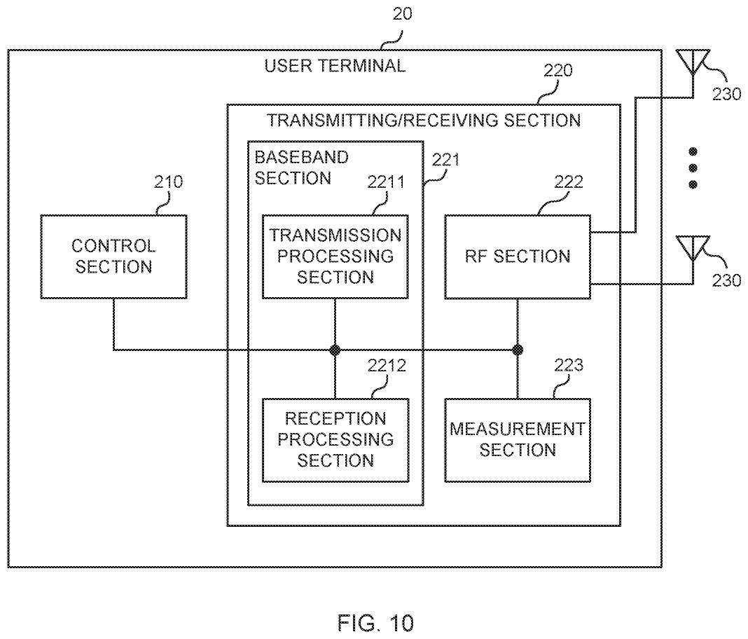

FIG. 10 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that the transmitting/receiving section 220 may, when the same Transmission Configuration Indication (TCI) state is applied to a downlink (DL) and an uplink (UL), receive a specific configuration for enabling or disabling initiation of activation of the TCI state by a UE. The control section 210 may initiate activation of the TCI state. The transmitting/receiving section 220 may transmit a specific report indicating whether to enable or disable initiation of activation of the TCI state by the UE.

The control section 210 may update a first number of active TCI states to a second number of new active TCI states, based on a channel state information (CSI) report.

The control section 210 may update a first number of active TCI states to a second number of new active TCI states, based on a report of the TCI state.

The transmitting/receiving section 220 may, when a separate Transmission Configuration Indication (TCI) state is applied to each of a downlink (DL) and an uplink (UL), receive a specific configuration for enabling or disabling initiation of activation of the TCI state of at least one of the UL and the DL by a UE. The control section 210 may initiate activation of the TCI state. The transmitting/receiving section 220 may transmit a specific report indicating whether to enable or disable initiation of activation of the TCI state of at least one of the UL and the DL by the UE.

The control section 210 may update a first number of active UL TCI states to a second number of new active UL TCI states, based on at least one of a UL channel state information (CSI) report, a Power Headroom Report (PHR), and a Maximum Permitted Exposure (MPE) report.

The control section 210 may update a first number of active UL TCI states to a second number of new active UL TCI states, based on a report of the TCI state in the UL.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

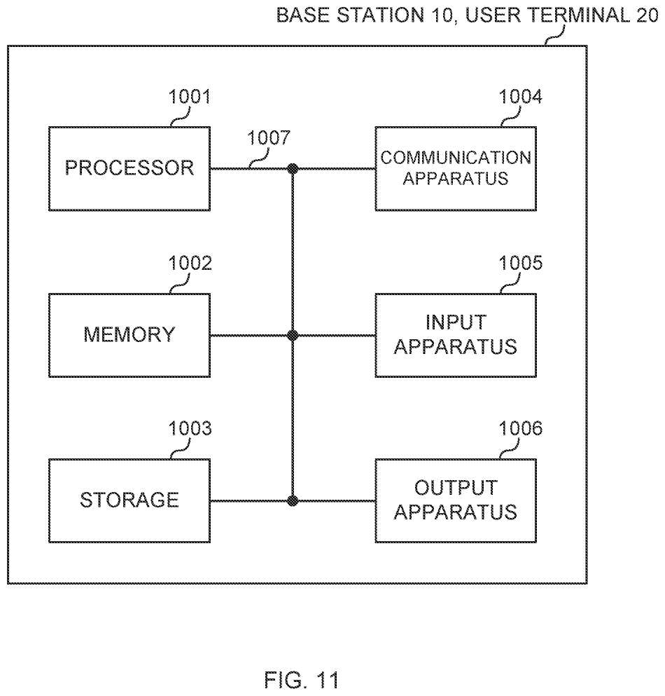

For example, a base station, a user terminal, and so on according to one embodiment of the present disclosure may function as a computer that executes the processes of the radio communication method of the present disclosure. FIG. 11 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part of all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIS.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ns.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “qNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

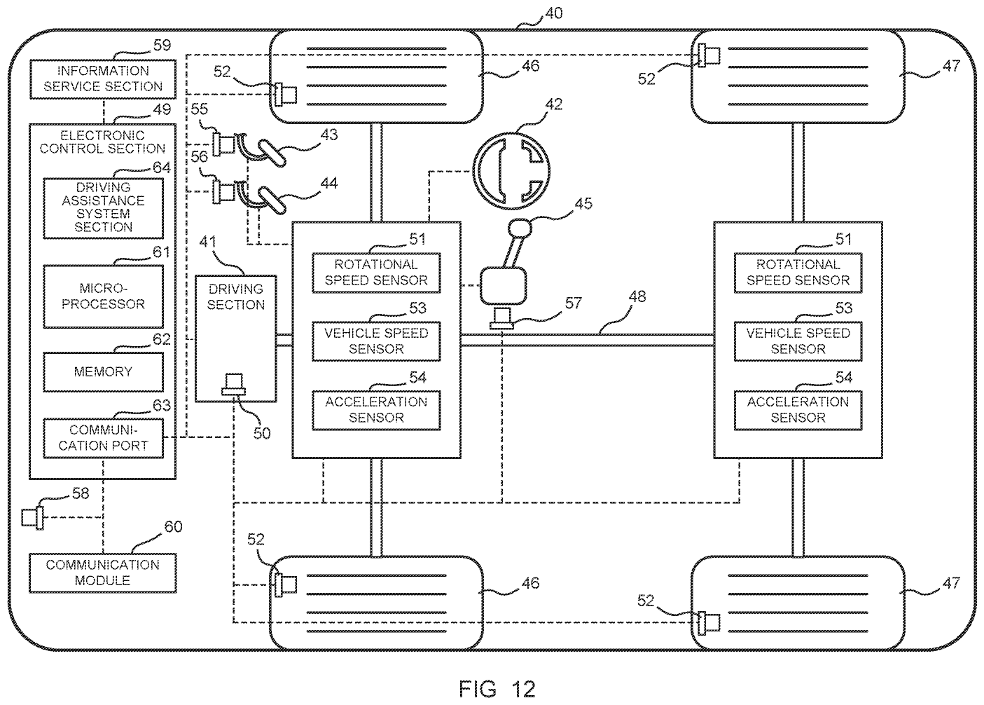

FIG. 12 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV)) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “sidelink”). For example, an uplink channel, a downlink channel, and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a receiving section that, when a separate Transmission Configuration Indication (TCI) state is applied to each of a downlink (DL) and an uplink (UL), receives a specific configuration for enabling or disabling initiation of activation of the TCI state of at least one of the UL and the DL by a UE; and
a control section that initiates activation of the TCI state.

2. The terminal according to claim 1, further comprising a transmitting section that transmits a specific report indicating whether to enable or disable initiation of activation of the TCI state of at least one of the UL and the DL by the UE.

3. The terminal according to claim 1, wherein the control section updates a first number of active UL TCI states to a second number of new active UL TCI states, based on at least one of a UL channel state information (CSI) report, a Power Headroom Report (PHR), and a Maximum Permitted Exposure (MPE) report.

4. The terminal according to claim 1, wherein the control section updates a first number of active UL TCI states to a second number of new active UL TCI states, based on a report of the TCI state in the UL.

5. A radio communication method for a terminal, the radio communication method comprising:
when a separate Transmission Configuration Indication (TCI) state is applied to each of a downlink (DL) and an uplink (UL), receiving a specific configuration for enabling or disabling initiation of activation of the TCI state of at least one of the UL and the DL by a UE; and
initiating activation of the TCI state.

6. A base station comprising:
a transmitting section that, when a separate Transmission Configuration Indication (TCI) state is applied to each of a downlink (DL) and an uplink (UL), transmits a specific configuration for enabling or disabling initiation of activation of the TCI state of at least one of the UL and the DL by a UE; and
a control section that controls transmission and reception, based on the TCI state whose activation is initiated by a terminal.

7. The terminal according to claim 2, wherein the control section updates a first number of active UL TCI states to a second number of new active UL TCI states, based on at least one of a UL channel state information (CSI) report, a Power Headroom Report (PHR), and a Maximum Permitted Exposure (MPE) report.

8. The terminal according to claim 2, wherein the control section updates a first number of active UL TCI states to a second number of new active UL TCI states, based on a report of the TCI state in the UL.
